(19) United States
(12) Patent Application Publication
(10) Pub. No.: US 2010/0295303 A1
(43) Pub. Date: Nov. 25, 2010

(54) Tethered system for power generation

(75) Inventors: Damon Vander Lind, Alameda, CA (US); Becker Van Niekerk, Alameda, CA (US); Corwin Hardham, San Francisco, CA (US)

Correspondence Address: VAN PELT, YI & JAMES LLP, 10050 N. FOOTHILL BLVD #200, CUPERTINO, CA, 95014, US

(73) Assignee: Makani Power, Inc.

(21) Appl. No.: 12/454,853

(22) Filed: May 21, 2009

(51) Int. Cl. H02P 9/04; B64C 13/16; B64C 3/00; B64D 35/00; G05D 1/08; G01S 15/08; F03D 9/00

(52) U.S. Cl. 290/44; 244/76 R; 244/75.1; 244/35 R; 244/60; 701/4; 367/99; 290/55

(57) ABSTRACT

A system for power generation comprises a wing, a turbine, a tether, and a tether tension sensor. The wing is for generating lift. The turbine is coupled to the wing and is used for generating power from rotation of a propeller or for generating thrust using the propeller. One end of the tether is coupled to the wing. The tether tension sensor is for determining a tension of the tether.

### BACKGROUND OF THE INVENTION

Systems for power generation often make use of the wind, an abundant natural resource. Wind power systems can extract large amounts of energy at distances high above the ground, where effects of the earth slowing the wind are reduced. However, deployment of a wind power system at a high altitude becomes complex, requiring apparatus to keep the wind power system at the high altitude (e.g., a mast or a structure producing lift) and a system to return the power to the ground.

### BRIEF DESCRIPTION OF THE DRAWINGS

Various embodiments of the invention are disclosed in the following detailed description and the accompanying drawings.

FIG. 1A is a diagram illustrating an embodiment of a tethered system for power generation.

FIG. 1B is a diagram illustrating an embodiment of a wing structure.

FIG. 1C is a block diagram illustrating an embodiment of a ground station for a tethered system for power generation.

FIG. 2 is a block diagram illustrating an embodiment of an electrical system for a tethered system for power generation.

FIG. 3 is a block diagram illustrating an embodiment of aircraft control systems.

FIG. 4 is a block diagram illustrating an embodiment of a wing instrumentation system.

FIG. 5A is a flow diagram illustrating an embodiment of a process for controlling a wing structure

FIG. 5B is a flow diagram illustrating an embodiment of a process for controlling a wing structure.

FIG. 6 is a flow diagram illustrating an embodiment of a process for designing a tethered system for power generation.

FIG. 7 is a flow diagram illustrating an embodiment of a process for powering a tethered system for power generation.

FIG. 8 is a flow diagram illustrating an embodiment of a process for distributing power generated by a tethered system for power generation.

FIG. 9 is a flow diagram illustrating an embodiment of a process for communicating information for a tethered system for power generation.

FIG. 10 is a flow diagram illustrating an embodiment of a process for communicating information from a tethered system for power generation with a ground station.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A tethered system for power generation is disclosed. The tethered system comprises a ground station, a tether, a wing structure with propeller system(s) and automatic control system(s). The wing structure is capable of flying to a high altitude using the propeller system(s) and then switching the propeller system(s) from propulsion mode to generator mode in order to extract energy from the oncoming wind. The wing structure is connected to a ground station via a tether and delivers the power generated to the ground station through the tether. Once the wing structure is generating power, automatic control system(s) is/are used to maintain its altitude and guide its flight path to try to optimize safety and power generation efficiency. In some embodiments, measurements of the angles between the ground station and the tether and the angles between the wing and the tether are used to enable a control system to achieve a desired flight path. In some embodiments, measurements of tether tension are used to maintain a desired tether tension.

In various embodiments, other sensors that measure position, speed, and/or orientation are used to enable a control system to control the wing including, for example, a global position sensor, an inertial measurement unit sensor, a radar position sensor, a radio frequency time of arrival sensor, an optical sensor, a wind speed sensor, a wind direction sensor, a tether tension sensor, a winch speed sensor, a power output sensor, an air pressure sensor, a temperature sensor, a line angle sensor, a light sensor, a light detection and ranging (LIDAR) system, a visible light sensor, a radio wave interferometric sensor, a radio detection and ranging (RADAR), a microwave sensor, an ultrasonic sensor, a sonar mapper, or any other appropriate sensor.

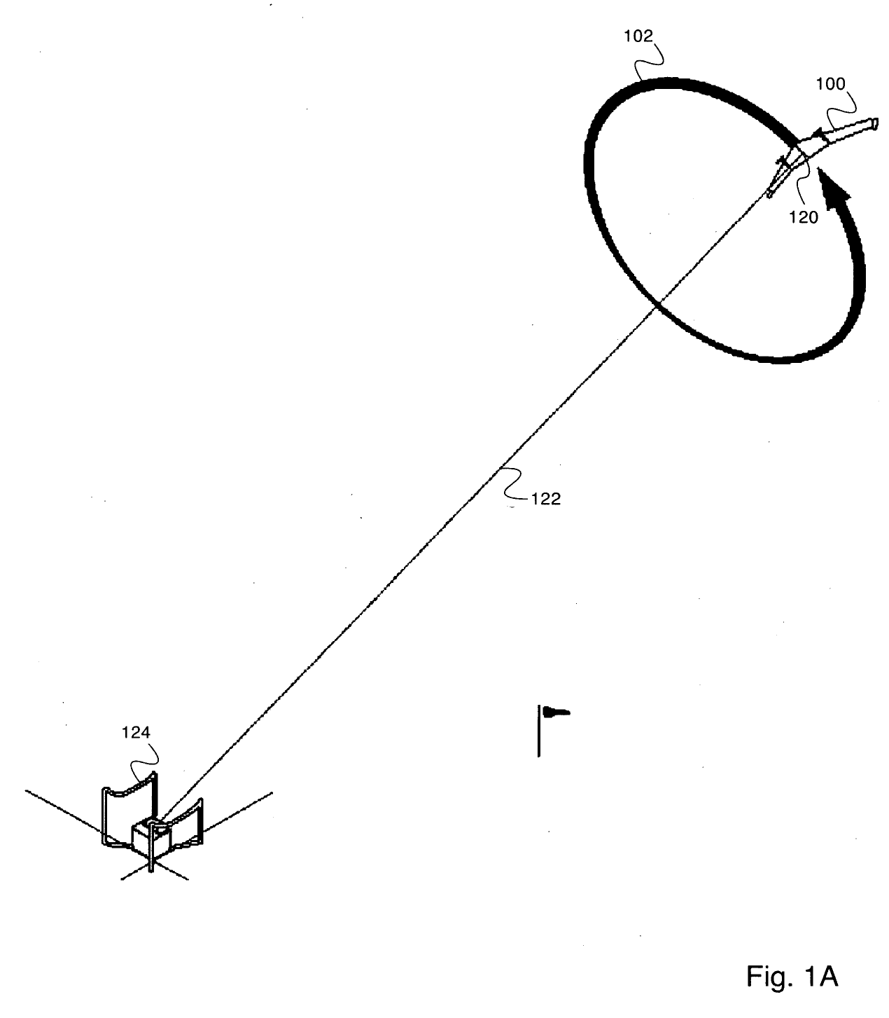

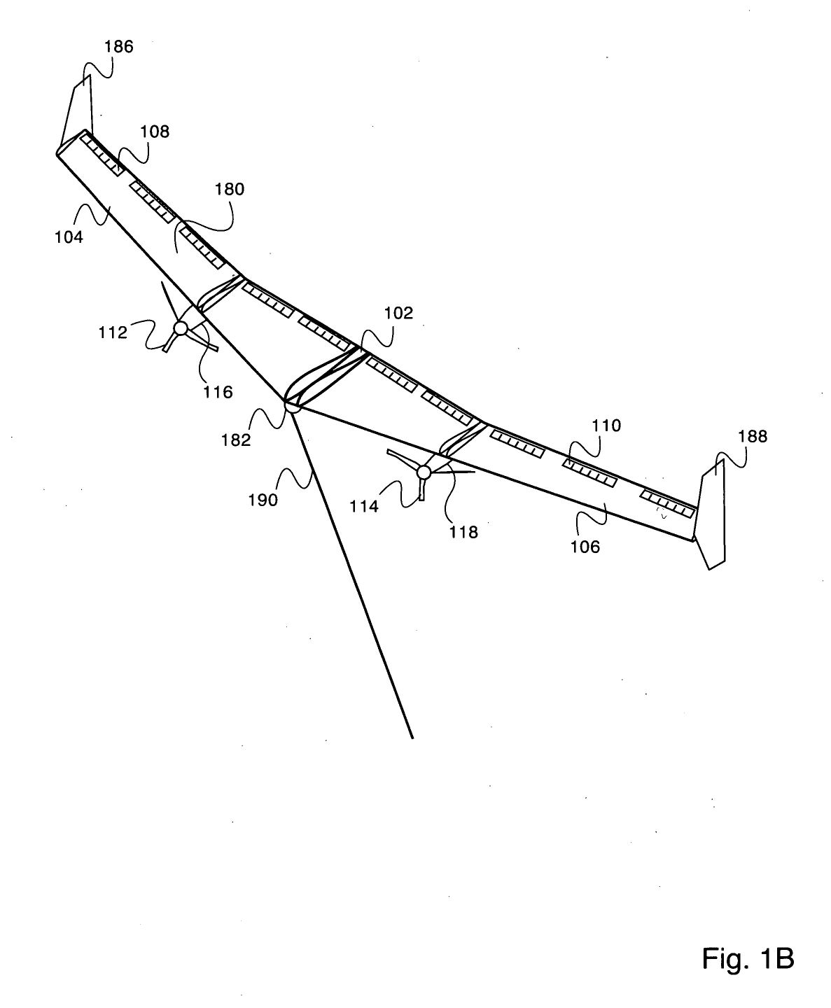

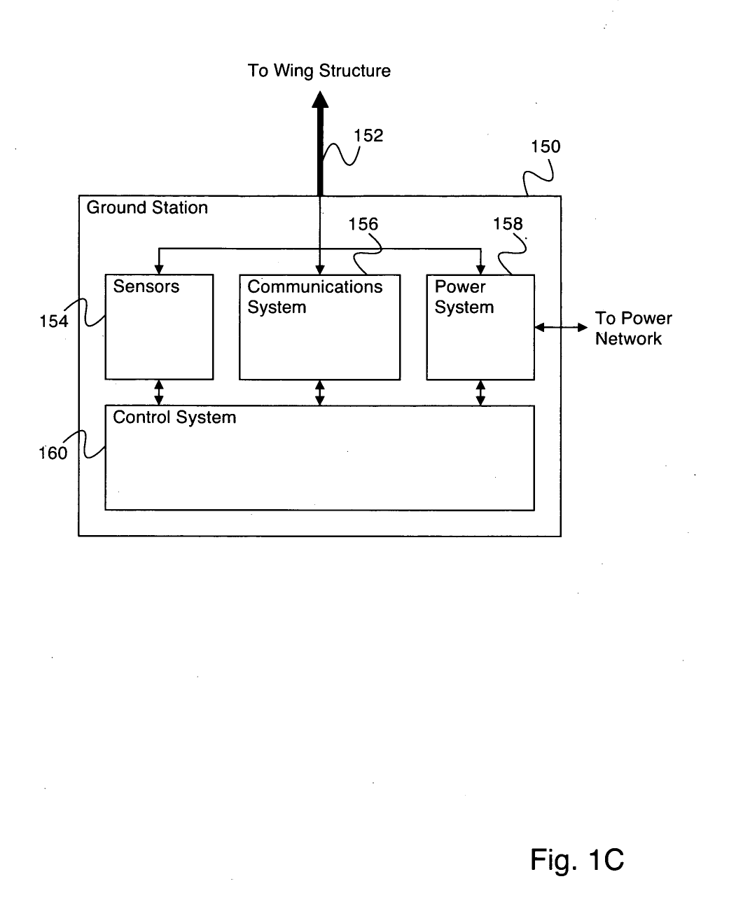

FIG. 1A is a diagram illustrating an embodiment of a tethered system for power generation. In the example shown, wing structure 100 comprises a tethered system for power generation. Wing structure 100 is tethered to ground station 124 via tether 122. In some embodiments, tether 122 comprises an electrical conductor. In various embodiments, the electrical conductor comprises an electrical conductor for power transfer, transmission of sensor measurements, transmission of control information, or for any other appropriate use of an electrical conductor. Ground station 124 couples tether 122 to the ground. In various embodiments, ground station 124 comprises a ground station for power collection, generation and transmission of wing structure control signals, collection of sensor measurements, or any other appropriate ground station activity. In some embodiments, ground station 124 comprises a plurality of structures with a plurality of functions (e.g., sensor functionality, control functionality, structural functionality, communication functionality, power functionality, etc.). Tether 122 is attached to wing structure 100 at tether mount 120. In some embodiments, tether mount 120 restricts the angle between tether 122 and wing structure 100 (e.g., only two degrees of freedom—for example, two rotation angles). In various embodiments, tether mount 120 comprises instrumentation for measuring the angle or position of tether 122, instrumentation for measuring the tension of tether 122, or any other appropriate instrumentation. In some embodiments, tether mount 120 serves as interface for instrumentation (e.g., accelerometers, tension sensors, etc.) mounted on tether 122. In various embodiments, tether mount 120 comprises an interface to an electrical conductor(s) for tether 122. The electrical conductor(s) transmit power, sensor measurements, control information, or any other appropriate electrical quantity. In some embodiments, tether mount 120 comprises tether gimbals for maintaining physical and electrical connections as the tether angle and tension vary. In some embodiments, tether 122 comprises a tether reinforcement structure to maintain the tether integrity in case of damage or wear. In some embodiments, tether 122 comprises a tether damage sensor to provide an alert in case of tether damage. In some embodiments, tether 122 connects to the wing through bridles. In various embodiments, tether 122 is coupled to or comprises wing bridling.

In various embodiments, ground station 124 is located on the ground, on a building or other structure on the ground, on water (e.g., a lake, an ocean, etc.), on a boat or other floating structure, or on any other appropriate surface.

In some embodiments, a plurality of tethered systems for power generation are electrically coupled in order to increase the power generation capacity of the system. In some embodiments, the plurality of tethered systems are located at sufficient distance from one another such that the wing structures will not collide with one another in normal operation. In some embodiments, the communications and control systems of the plurality of tethered systems share information with one another such that the flight paths of the wing structures are synchronized, enabling a higher packing density of the plurality of tethered systems.

FIG. 1B is a diagram illustrating an embodiment of a wing structure. In some embodiments, wing structure 180 comprises wing structure 100 of FIG. 1A. In the example shown, tether mount 182 is coupled to wing structure 180. Tether 190 is coupled to tether mount 182. Wing structure 180 comprises center section 102, wing airfoil section 104 and wing airfoil section 106, one or more turbines (e.g., turbine inside pylon 116 and turbine inside pylon 118) attached to propellers (e.g., propeller 112 and propeller 114), and winglet 186 and winglet 188. In various embodiments, winglet 186 and winglet 188 or wing structure 100 include landing gear. In some embodiments, tether mount 182 is coupled to wing airfoil section 104, wing airfoil section 106, or to any other appropriate attachment point. Wing airfoil section 104 and wing airfoil section 106 are coupled to center section 102. Center section 102 includes in its interior spaces control electronics, power distribution electronics, aircraft instrumentation, or any other appropriate electronics.

Wing airfoil section 104 and wing airfoil section 106 comprise airfoils designed to produce lift in response to air flow relative to the wing. In some embodiments, wing airfoil section 104 and wing airfoil section 106 include electrical conductors in the interior for power transfer, transmission of sensor measurements, transmission of control information, or any other appropriate electrical conductors. In various embodiments, wing airfoil section 104 and wing airfoil section 106 are identical, mirror image structures designed to produce identical amounts of lift, designed to produce different amounts of lift, or are any other appropriate geometric configuration. In some embodiments, only one of wing airfoil section 104 and wing airfoil section 106 is present. Wing airfoil section 104 comprises trailing edge/winglet module 108 and wing airfoil section 106 comprises trailing edge/winglet module 110. In various embodiments, trailing edge/winglet module 108 and trailing edge/winglet module 110 include air flow speed sensor(s), air flow direction sensor(s), air pressure sensor(s) (e.g., pitot tubes), orientation sensor(s), temperature sensor(s), ultrasonic range finding sensor(s), wing flutter sensor(s), or any other appropriate sensors. In various embodiments, trailing edge/winglet module 108 and trailing edge/winglet module 110 comprise actuator(s) for trailing edge flap(s), actuator(s) for winglet device(s), actuator(s) for wing angle control, servo-actuator(s), or any other appropriate actuators. In some embodiments, the wing comprises a number of lift generating surfaces. In some embodiments, the wing comprises one or more flaps for controlling an orientation of the wing. In some embodiments, a wing comprises one or more lift generating surfaces. In various embodiments, the system for wind power generation comprises a plurality of wings, a plurality of wing surfaces, configurations where a tether is coupled to one or more pylons, or any other appropriate configuration of a wing, a tether, and a propeller and/or turbine coupled to a motor and/or generator.

In the example shown, pylon 116 and propeller 112 are mounted on wing airfoil section 104 and pylon 118 and propeller 114 are mounted on wing airfoil section 106. Propeller 112 and propeller 114 comprise airfoils designed to produce air flow when rotated or to rotate when subjected to air flow. Pylon 116 and pylon 118 house motors/generators for converting electricity into rotation and for converting rotation into electricity. In some embodiments, pylon 116 and pylon 118 are faired to minimize air resistance. In some embodiments, ducted fans are used in place of propellers.

FIG. 1C is a block diagram illustrating an embodiment of a ground station for a tethered system for power generation. In some embodiments, ground station 150 of FIG. 1C comprises ground station 124 of FIG. 1A. In the example shown, ground station 150 is coupled to tether 152. Tether 152 is coupled at the other end from ground station 150 to a wing structure (e.g., wing structure 100 of FIG. 1A). Tether 152 comprises an electrical conductor. In various embodiments, the electrical conductor comprises an electrical conductor for power transfer, transmission of sensor measurements, transmission of control information, or for any other appropriate use of an electrical conductor.

In the example shown, tether 152 is electrically coupled to sensors 154, communication system 156, and power system 158. In various embodiments, sensors 154 comprise tether tension sensors, tether acceleration sensors, tether angular rate sensors, tether angle sensors, temperature sensors, wind sensors, or any other appropriate sensors. Communication system 156 comprises a system for transmitting signals on tether 152 and a system for receiving signals on tether 152. Power system 158 is coupled to a power network. Power system 158 comprises a system for transmitting power from the power network to tether 152 and a system for transmitting power from tether 152 to the power network. Control system 160 comprises a system for controlling communication system 156 and power system 158. Control system 160 controls communication system 156 and power system 158 based at least in part on measurements from sensors 154, on external input (e.g., control input from a user, control input from another power generating system, etc.).

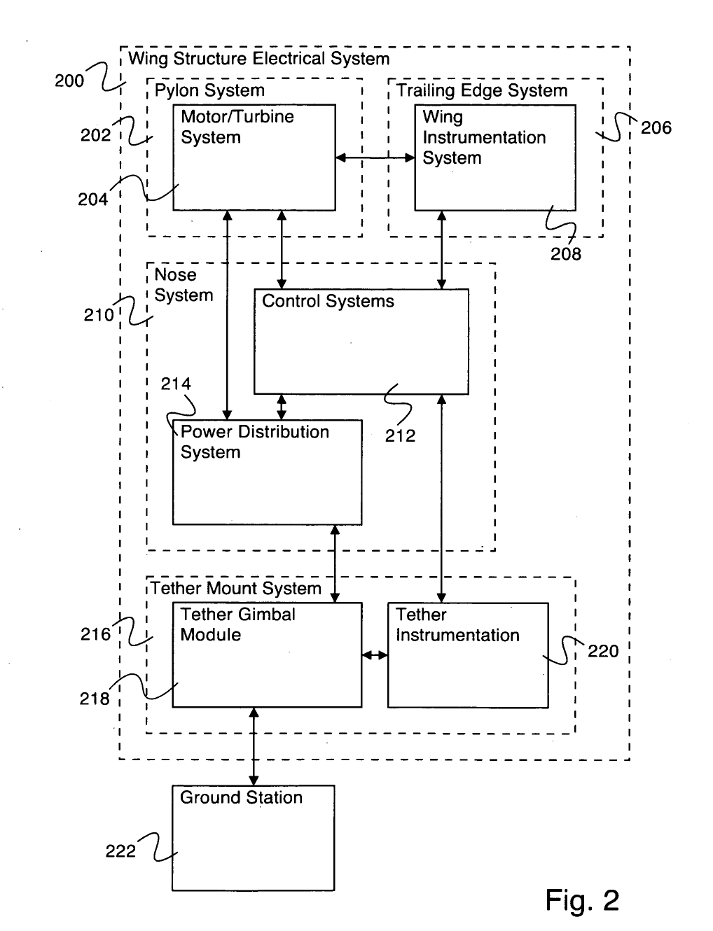

FIG. 2 is a block diagram illustrating an embodiment of an electrical system for a tethered system for power generation. In some embodiments, the block diagram of FIG. 2 represents the electrical systems of aircraft 100 and ground station 124 of FIG. 1. In the example shown, wing structure electrical system 200 represents the electrical system of wing structure 100 of FIG. 1. Wing structure electrical system 200 includes pylon system 202, trailing edge system 206, nose system 210, and tether system 216.

In the example shown, pylon system 202 represents the electrical system in pylon 116 and pylon 118 of FIG. 1. Pylon system 202 comprises motor/turbine system 204. Motor/turbine system 204 converts electrical power into rotation, turning propeller 112 and/or propeller 114 of FIG. 1. Motor/turbine system 204 converts rotation of propeller 112 and/or propeller 114 of FIG. 1 into electrical power. In some embodiments, motor/turbine system 204 comprises a motor/turbine system for each of propeller 112 and propeller 114 of FIG. 1. When motor/turbine system 204 is used to generate electrical power, the power is sent to power distribution system 214 and to wing instrumentation 208. When motor/turbine system 204 is used to generate rotation from electrical power, the power is received from power distribution 214. Control information for motor/turbine system 204 is received from control systems 212. In various embodiments, cyclic or collective pitch or speed control of a propeller (e.g., propeller 112 and propeller 114) are used in place of or in addition to other aerodynamic surfaces for control.

Trailing edge system 206 represents the electrical system of trailing edge/winglet module 108 and trailing edge/winglet module 110. Trailing edge system 206 comprises wing instrumentation system 208. In some embodiments, wing instrumentation system 208 comprises a wing instrumentation system for each of trailing edge/winglet module 108 and trailing edge/winglet module 110 of FIG. 1. In various embodiments, wing instrumentation 208 comprises air flow speed sensors, air flow direction sensors, air pressure sensors, orientation sensors, temperature sensors, ultrasonic range finding sensors, wing flutter sensors, or any other appropriate sensors. In various embodiments, wing instrumentation 208 comprises actuators for trailing edge flaps, actuators for winglet devices, actuators for wing angle control, servo-actuators, or any other appropriate actuators. Wing instrumentation system 208 receives control information from control systems 212. In various embodiments, wing instrumentation system 208 controls its actuators based on measurements from its sensors, based on control information received from control systems 212, based on a combination of one or more of measurements received from its sensors and control information received from control systems 212, or based on any other appropriate signals or measurements.

In some embodiments, nose system 210 represents the electrical system of center section 102 of FIG. 1B. Nose system 210 comprises power distribution system 214 and control systems 212. When motor/turbine system 204 is generating electrical power, the power is transmitted to power distribution system 214. Power distribution system 214 transmits the power to control systems 212 and to tether gimbal module 218, where it is transmitted through the tether (e.g., tether 122 of FIG. 1A) to ground station 222. When motor/turbine system 204 is using electrical power to turn propellers, the energy is transmitted through the tether and tether gimbal module 218 and is distributed by power distribution system 214 to motor/turbine system 204 and to control systems 212.

Control systems 212 are the main control systems for the aircraft. Control systems 212 send control information to motor/turbine system 204 and to wing instrumentation system 208 and receive sensor information from wing instrumentation 208 and tether instrumentation 220. In various embodiments, control systems 212 send control information to motor/turbine system 204 and to wing instrumentation system 208 in order to guide the aircraft along a path calculated for maximum power generation, minimum power consumption, minimum air resistance, maximum net power output, minimum probability of crashing, minimum control surface wear, or any other appropriate path. In various embodiments, control systems 212 send control information to motor/turbine system 204 and to wing instrumentation system 208 in order to guide the measured tether angles to specific values, in order to guide the measured tether angles along a predetermined path, in order to guide the measured tether angles along a dynamically calculated path, or in order to guide the measured tether angles to values determined in any other appropriate way.

Control systems 212 additionally convert high voltage power from power distribution system 214 to low voltage and distribute it to power controllers and instrumentation in motor/turbine system 204, wing instrumentation system 208, and tether instrumentation 220.

In some embodiments, tether mount system 216 represents the electrical system of tether mount 120 of FIG. 1A. Tether mount system 216 comprises tether gimbal module 218 and tether instrumentation 220. Tether gimbal module 218 comprises tether gimbals for maintaining physical and electrical connections as the tether angle and tension vary. In various embodiments, tether gimbal module 218 comprises electrical connections for transmitting power from the aircraft into the tether, for transmitting power from the tether into the aircraft, for transmitting measurements or control information from the aircraft to the tether, for transmitting measurements or control information from the tether to the aircraft, or for transmitting any other appropriate electrical quantity on to or off of the aircraft. Tether instrumentation 220 comprises instrumentation for measuring the angle of the tether, instrumentation for measuring the tension of the tether, instrumentation mounted directly on the tether (e.g., accelerometers), or any other appropriate instrumentation. Tether instrumentation 220 transmits measurements received by tether gimbal module 218 from the tether and measurements made by tether instrumentation 220 to control systems 212.

Ground station 222 is connected to the ground end of the tether. In some embodiments, ground station 222 comprises ground station 150 of FIG. 1C. In various embodiments, ground station 222 comprises a ground station for power collection, generation and transmission of aircraft control signals, collection of sensor measurements, or any other appropriate ground station activity.

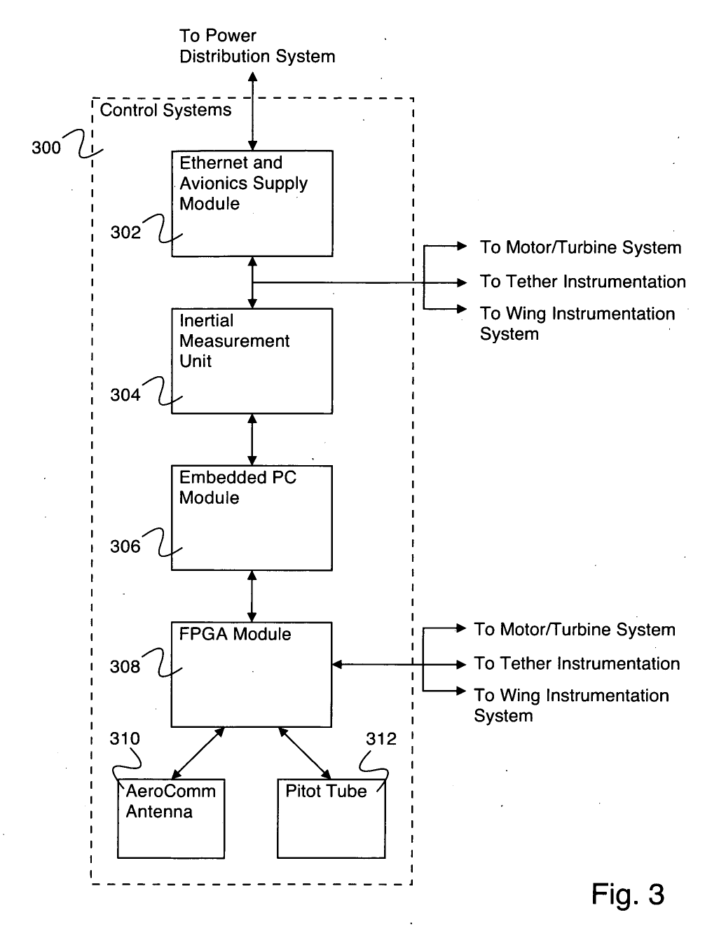

FIG. 3 is a block diagram illustrating an embodiment of aircraft control systems. In some embodiments, control systems 300 represents the systems of control systems 212 of FIG. 2. In the example shown, control systems 300 comprise Ethernet and avionics supply module 302, inertial measurement unit 304, embedded computer module 306, FPGA module 308, antenna 310, and pitot tube 312. Ethernet and avionics supply module 302 receives high voltage power from the power distribution system (e.g., power distribution system 214 of FIG. 2) and supplies low voltage power to the remainder of control systems 300, as well as controllers and instrumentation in the motor/turbine system (e.g., motor/turbine system 202 of FIG. 2), the tether instrumentation (e.g., tether instrumentation 220 of FIG. 2), and the wing instrumentation system (e.g., wing instrumentation system 208 of FIG. 2). Ethernet and avionics supply module 308 also receives and transmits communication to the ground station by modulating and demodulating signals over the high voltage conductor lines. Inertial measurement unit 304 measures acceleration and/or tilt (e.g., rotation) of the aircraft. Measurements from inertial measurement unit 304 are communicated directly to embedded computer module 306. In some embodiments, embedded computer module 306 uses measurements from inertial measurement unit 304 to calculate the position and velocity of the aircraft. Ethernet is coupled to embedded computer module 306.

Embedded computer module 306 is the master controller for the aircraft, processing signals from the sensor systems and sending commands to the actuator systems. In various embodiments, embedded computer module 306 sends commands to the actuator systems in order to guide the aircraft along a path calculated for maximum power generation, minimum power consumption, minimum air resistance, maximum net power output, or any other appropriate path. In various embodiments, embedded computer module 306 sends commands to the actuator systems in order to guide the measured tether angles to constant values, in order to guide the measured tether angles along a predetermined path, in order to guide the measured tether angles along a dynamically calculated path, or in order to guide the measured tether angles to values determined in any other appropriate way. Embedded computer module 306 receives signals from the motor/turbine system, the tether instrumentation, the wing instrumentation system, antenna 310, and Pitot tube 312 via FPGA module 308, and receives signals directly from inertial measurement unit 304. Embedded computer module 306 sends control signals to the motor/turbine system and to the wing instrumentation system via FPGA module 308. FPGA module 308 interfaces embedded computer module 306 to the large number of sensor and actuator signals present in the aircraft, performing multiplexing and demultiplexing, transmission of control signals in response to system state message, temporary data storage, or any other appropriate interfacing functions. antenna 310 receives transmissions from a ground station, from other aircraft, or from any other appropriate transmitting source. Transmissions received by antenna 310 are processed by FPGA module 308 and communicated to embedded computer module 306. Pitot tube 312 is an air speed measurement instrument (e.g., wind speed). Measurements from Pitot tube 312 are processed by FPGA module 308 and communicated to embedded computer module 306.

In some embodiments, control systems 300 comprise other configurations of hardware and software modules configured to control the tethered power system.

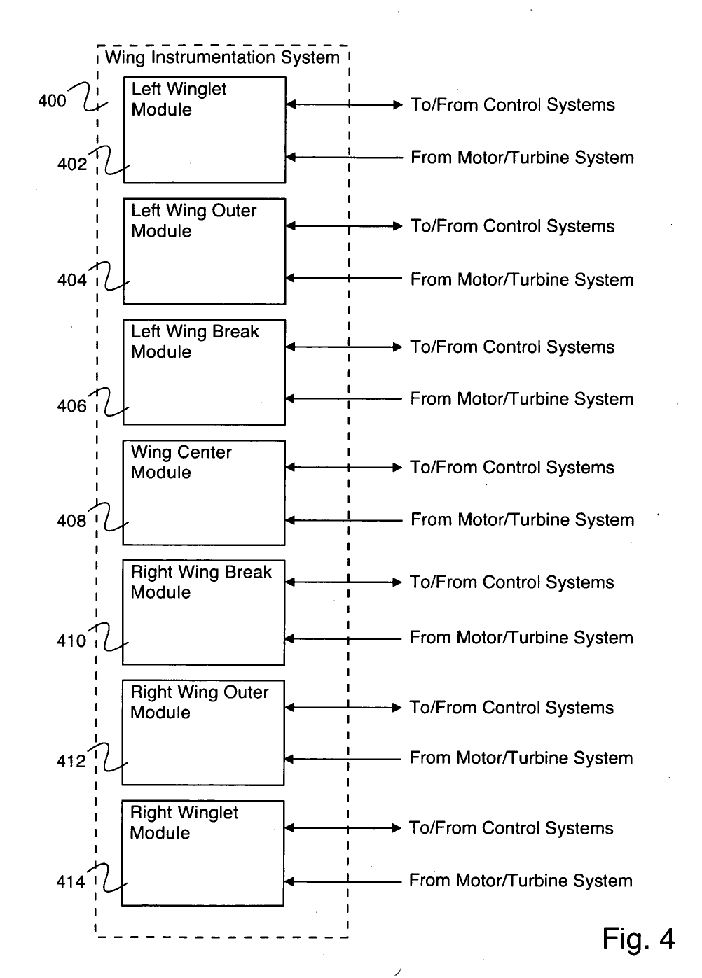

FIG. 4 is a block diagram illustrating an embodiment of a wing instrumentation system. In some embodiments, wing instrumentation system 400 represents wing instrumentation system 208 of FIG. 2. In the example shown, wing instrumentation system 400 comprises left winglet module 402, left wing outer module 404, left wing break module 406, wing center module 408, right wing break module 401, right wing outer module 412, and right winglet module 414. Left winglet module 402 comprises servomotors for adjustment of the left winglet and instrumentation for detecting wing flutter. Left winglet module 402 receives servomotor control information from the control systems (e.g., control systems 212 of FIG. 2) and servomotor power from the motor/turbine system (e.g., motor/turbine system 204 of FIG. 2). Measurements from the wing flutter instrumentation are sent from left winglet module 402 to the control systems. Left wing outer module 404 comprises servomotors for adjustment of the left wing outer flaps. Left wing outer module 404 receives servomotor control information from the control systems and servomotor power from the motor/turbine system. Measurements from the left wing outer flaps are sent from left wing outer module 404 to the control systems. Left wing break module 406 comprises servomotors for adjustment of left wing break spacing. Left wing break module 406 receives servomotor control information from the control systems and servomotor power from the motor/turbine system. Wing center module 408 comprises servomotors for adjustment of the aircraft center flaps and an ultrasonic rangefinder for use in takeoff and landing. Wing center module 408 receives servomotor control information from the control systems and servomotor power from the motor/turbine system. Measurements from the ultrasonic rangefinder are sent from wing center module 408 to the control systems.

Right wing break module 410 comprises servomotors for adjustment of right wing break. Right wing break module 410 receives servomotor control information from the control systems and servomotor power from the motor/turbine system. Measurements of the right wing break spacing are sent from right wing break module 410 to the control systems. Right wing outer module 412 comprises servomotors for adjustment of the right wing outer flaps. Right wing outer module 412 receives servomotor control information from the control systems and servomotor power from the motor/turbine system. Measurements from the right wing outer flaps are sent from right wing outer module 412 to the control systems. Right winglet module 414 comprises servomotors for adjustment of the right winglet and instrumentation for detecting wing flutter. Right winglet module 414 receives servomotor control information from the control systems and servomotor power from the motor/turbine system. Measurements from the wing flutter instrumentation are sent from right winglet module 414 to the control systems.

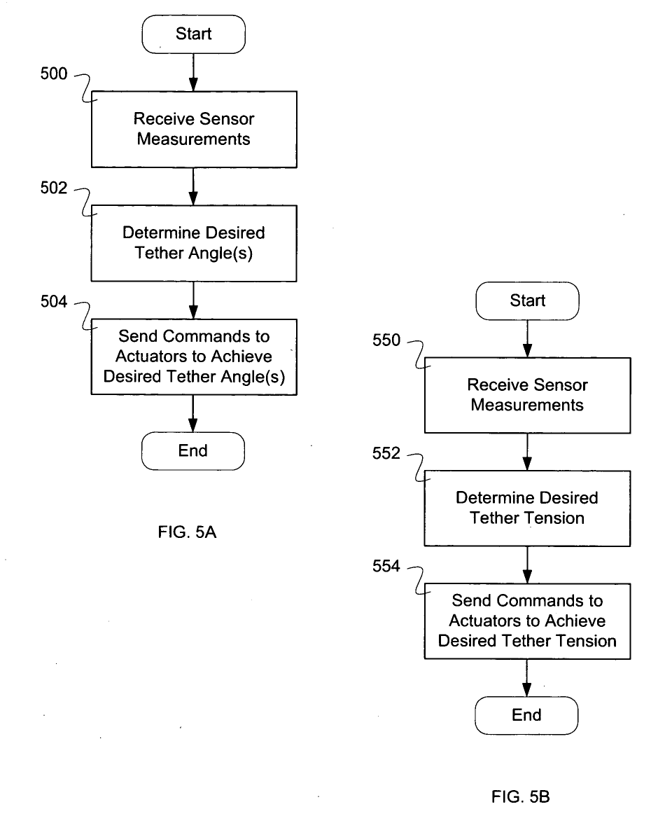

FIG. 5A is a flow diagram illustrating an embodiment of a process for controlling a wing structure. In some embodiments, the process of FIG. 5A is used by embedded computer module 306 of FIG. 3 to control wing structure 100 of FIG. 1A. In the example shown, in 500, sensor measurement(s) is/are received. In various embodiments, sensor measurements are received from the motor/turbine system (e.g., motor/turbine system 204 of FIG. 2), the tether instrumentation (e.g., tether instrumentation 220 of FIG. 2), the wing instrumentation system (e.g., wing instrumentation system 208 of FIG. 2), the antenna (e.g., antenna 310 of FIG. 3), the Pitot tube (e.g., Pitot tube 312 of FIG. 3), the inertial measurement unit (e.g., inertial measurement unit 304 of FIG. 3), or any other appropriate sensor or sensor system. In 502, desired tether angle(s) is/are determined. In various embodiments, the desired tether angle(s) is/are determined to be a constant value, the desired tether angle(s) is/are determined to be an angle associated with a predetermined path, the desired tether angle(s) is/are determined to be an angle associated with a dynamically calculated path, or the desired tether angle(s) is/are determined in any other appropriate way. In various embodiments, the desired tether angle(s) is/are determined in order to guide the aircraft along a path calculated for maximum power generation, minimum power consumption, minimum air resistance, maximum net power output, or any other appropriate metric. In 504, commands are sent to actuators to achieve the desired tether angle(s). In various embodiments, commands are sent to the motor/turbine system, the wing instrumentation system, or any other appropriate actuator or actuator system.

In various embodiments, other desired measurements are used by the controller to achieve a desired position, path, or orientation; for example, a measurement from an inertial measurement unit, a radar, a global position system (GPS), or any other appropriate measurement system or combination of measurement systems.

FIG. 5B is a flow diagram illustrating an embodiment of a process for controlling a wing structure. In some embodiments, the process of FIG. 5B is used by embedded computer module 306 of FIG. 3 to control wing structure 100 of FIG. 1A. In various embodiments, a tether tension sensor produces a tether tension measurement and comprises one or more of the following: an angle of attack sensor, a pitch rate sensor, an air speed sensor, an orientation sensor, or any other appropriate tether tension sensor or measurement determiner. In the example shown, in 550, sensor measurement(s) is/are received. In various embodiments, sensor measurements are received from the motor/turbine system (e.g., motor/turbine system 204 of FIG. 2), the tether instrumentation (e.g., tether instrumentation 220 of FIG. 2), the wing instrumentation system (e.g., wing instrumentation system 208 of FIG. 2), the antenna (e.g., antenna 310 of FIG. 3), the Pitot tube (e.g., Pitot tube 312 of FIG. 3), the inertial measurement unit (e.g., inertial measurement unit 304 of FIG. 3), or any other appropriate sensor or sensor system. In 552, desired tether tension is determined. In various embodiments, the desired tether tension is determined to be a constant value, the desired tether tension is determined to be below a predetermined maximum, above a predetermined minimum, or within a predetermined range, or the desired tether tension is determined in any other appropriate way. In various embodiments, the desired tether tension is determined in order to target maximum power generation, minimum power consumption, minimum air resistance, maximum net power output, minimum risk of damage to the tether, or any other appropriate metric. In 554, commands are sent to actuators to achieve the desired tether tension. In various embodiments, commands are sent to the motor/turbine system, the wing instrumentation system, or any other appropriate actuator or actuator system.

In various embodiments, other desired measurements are used by the controller to achieve a desired position, path, tether tension, or orientation; for example, a measurement from an inertial measurement unit, a radar, a global position system (GPS), or any other appropriate measurement system or combination of measurement systems.

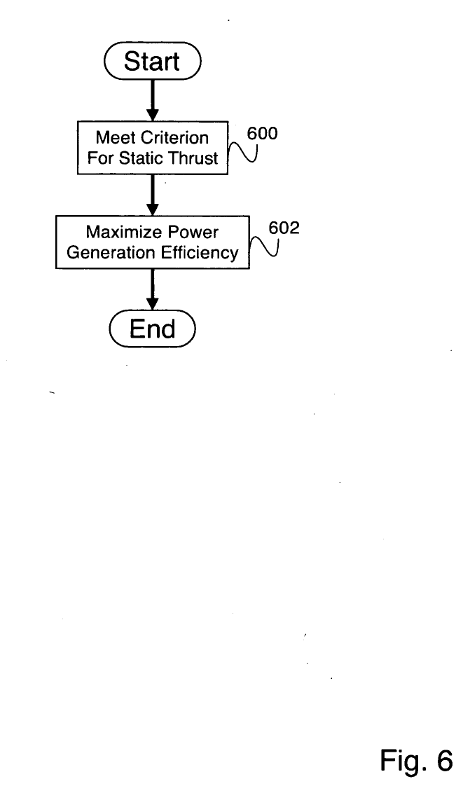

FIG. 6 is a flow diagram illustrating an embodiment of a process for designing a tethered system for power generation. In some embodiments, the process of FIG. 6 is used for designing the tethered system for power generation of FIG. 1A. In the example shown, in 600, a criterion for static thrust is met. For example, the criterion for static thrust is that the static thrust (e.g., of the propeller and turbine system as it is able to thrust the wing structure) is above a minimum value chosen for safety. In various embodiments, the minimum value for static thrust is one and a half times the wing weight, two times the wing weight, three times the wing weight, or any other appropriate value.

In 602, the power generation efficiency of the tethered system for power generation is optimized. For example, the efficiency of the tethered system for power generation is optimized by choosing a set of design parameters appropriately. In various embodiments, the design parameters that are chosen when optimizing the efficiency comprise one or more of the following: a ratio of incoming wind speed to propeller blade tip speed, a maximum propeller blade tip speed, a propeller blade area, a propeller blade cross-sectional shape, a fixed vs. a variable pitch propeller blade for the system, a wing area, a nominal speed of flight, a tether length, a tether cross-sectional area, a total material weight, a total material cost, or any other appropriate design parameter. In some embodiments, the tethered system for power generation is designed to meet the criterion for static thrust at the same time as the power generation efficiency of the tethered system is optimized. In some embodiments, computer optimization is used to choose the design parameters to meet the criterion for static thrust first and then to optimize the power generation efficiency of the tethered system. The power generation efficiency of the system is computed as the ratio of the total power generated to the total power expended. The total power generated is calculated by integrating the power generated over a model set of wind conditions and flight patterns. The total power expended is calculated by integrating the power expended over a model set of wind conditions and flight patterns. After the power generation efficiency of the tethered system has been optimized, the process ends.

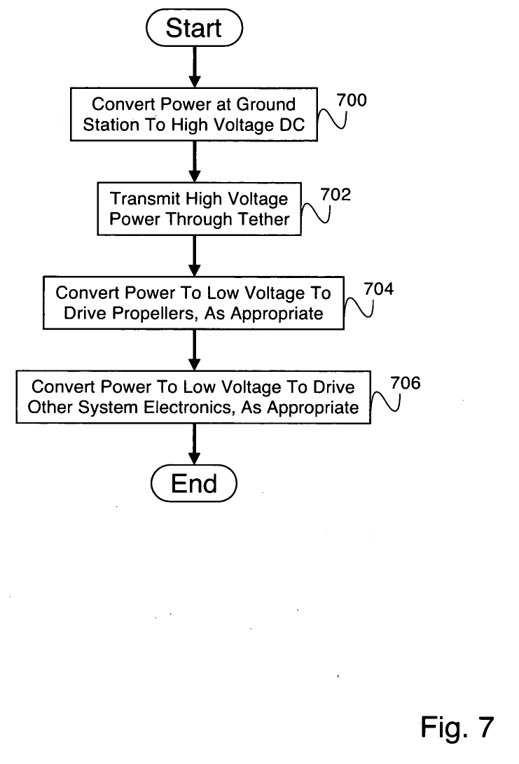

FIG. 7 is a flow diagram illustrating an embodiment of a process for powering a tethered system for power generation. In some embodiments, the tethered system for power generation is the tethered system for power generation of FIG. 1A. In some embodiments, the tethered system is powered in order to drive its propeller(s) to enable it to fly to a target altitude. In some embodiments, the tethered system for power generation begins generating power only once it has reached a target altitude. In the example shown, in 700, power at the ground station (e.g., ground station 150 of FIG. 1C) is converted to high voltage direct current (DC). In some embodiments, the power is converted by a power system (e.g., power system 158 of FIG. 1C). In some embodiments, the power is 3 phase alternating current (AC). In some embodiments, the power is converted from AC grid voltage (e.g., 120 Volts AC, 240 Volts AC, 5 KVolts AC, etc.) to DC before being converted to high voltage. In some embodiments, the value of high voltage to which the power is converted depends on the designed power generation capacity of the tethered system for power generation. In various embodiments, the power is converted to 500 V, 1000 V, 20000 V, or any other appropriate high voltage. In 702, the high voltage power is transmitted through the tether (e.g., tether 152 of FIG. 1C). In some embodiments, the tether diameter is selected as a compromise between minimizing the tether resistance (e.g., by making the tether diameter larger) and minimizing the tether weight (e.g., by making the tether diameter smaller). In some embodiments, the high voltage is selected as a compromise between minimizing the tether current (e.g., by increasing the high voltage) and minimizing the requirements on tether insulation weight (e.g., by decreasing the high voltage).

In 704, the power is converted to low voltage to drive the propellers, as appropriate. In some embodiments, the high voltage selected in 700 is higher than the desired voltage to drive the propellers, and the voltage is converted to the desired voltage to drive the propellers (e.g., propeller 112 or propeller 114 of FIG. 1B). In some embodiments, the high voltage selected in 700 is the desired voltage to drive the propellers, and voltage conversion is not necessary. In 706, the power is converted to a low voltage to drive the other system electronics, as appropriate. In some embodiments, the other electronics on the tethered system for power generation are powered by a lower voltage than the voltage transmitted on the tether or the voltage desired to drive the propellers, and the voltage must be converted drive them. In some embodiments, power to drive the other system electronics is transmitted on a separate conductor from the power to drive the propellers, and is already at the appropriate voltage to drive the electronics. In some embodiments, power to drive the other system electronics is transmitted on a separate conductor from the power to drive the propellers, and is at a high voltage (e.g., to minimize the current transmitted on the separate conductor). The power transmitted on the separate conductor then needs to be converted to a low voltage to drive the other electronics on the system. After the power has been converted to a low voltage to drive the other system electronics, as appropriate, the process ends.

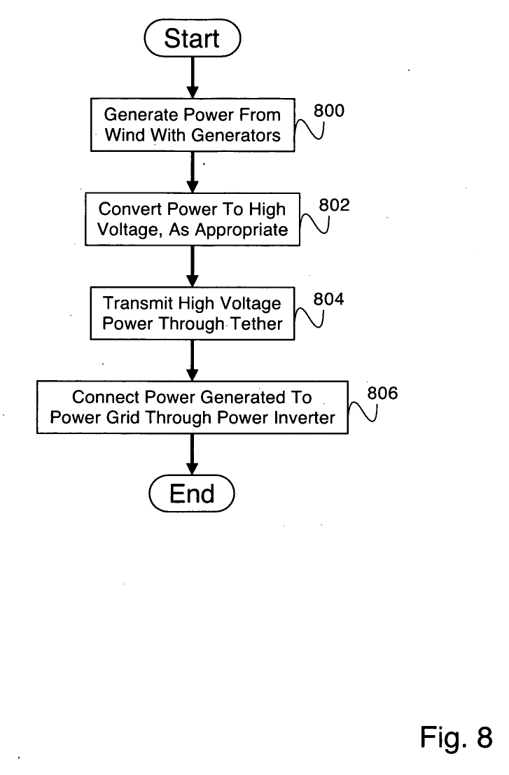

FIG. 8 is a flow diagram illustrating an embodiment of a process for distributing power generated by a tethered system for power generation. In some embodiments, the tethered system for power generation is the tethered system for power generation of FIG. 1A. In some embodiments, the system only begins generating power once it has reached a target altitude. In the example shown, in 800, power is generated from wind with generators (e.g., generators housed in pylon 116 and pylon 118 of FIG. 1B). In 802, the power is converted to high voltage as appropriate. In some embodiments, power is generated by the generators at high voltage. In some embodiments, power is generated by the generators at low voltage and converted to high voltage before it is transmitted. In 804, the high voltage power is transmitted through the tether (e.g., tether 152 of FIG. 1C) to the ground station (e.g., ground station 150 of FIG. 1C). In some embodiments, the high voltage is selected as a compromise between minimizing the tether current (e.g., by increasing the high voltage) and minimizing the requirements on tether insulation weight (e.g., by decreasing the high voltage). In 806, the ground station connects the power generated to the power grid through a power inverter, and the process ends. In some embodiments, the power is connected to the power grid by a power system (e.g., power system 158 of FIG. 1C).

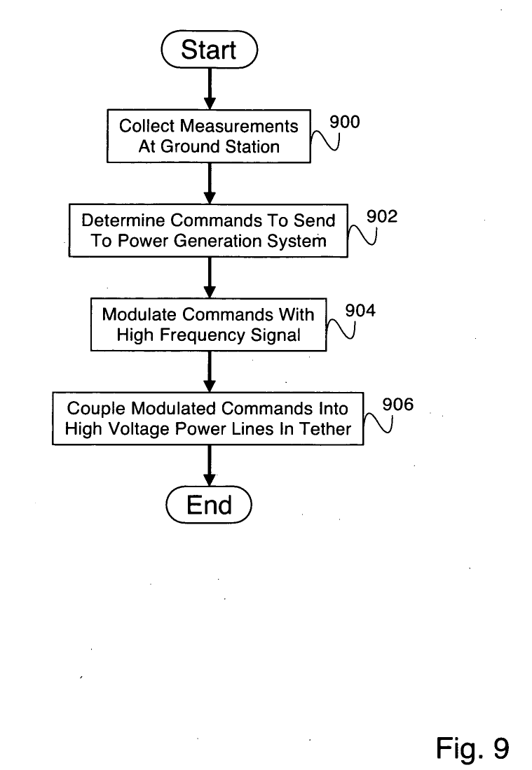

FIG. 9 is a flow diagram illustrating an embodiment of a process for communicating information for a tethered system for power generation. In some embodiments, the tethered system for power generation is the tethered system for power generation of FIG. 1A. In the example shown, in 900, measurements are collected at the ground station (e.g., ground station 150 of FIG. 1C). In some embodiments, measurements are collected by a set of sensors (e.g., sensors 154 of FIG. 1C). In various embodiments, measurements are collected of temperature, ground wind speed, ground wind direction, tether (e.g., tether 152 of FIG. 1C) angle, tether tension, or any other appropriate quantity. In some embodiments, signals are received. In various embodiments, signals are received from other tethered systems for power generation, from nearby wing structures, from an air traffic control center, from other nearby airspace users, or from any other appropriate signal source. In 902, command(s) is/are determined to send to the power generation system. In some embodiments, the command(s) is/are determined from the measurements collected and/or the signals received. In some embodiments, the commands are determined by a controller (e.g., controller 160 of FIG. 1C). In various embodiments, commands comprise one or more of the following: speed commands, direction commands, commands to start generating power, commands to stop generating power, commands to return to the ground, and/or any other appropriate commands for the power generation system. In 904, the commands are modulated with a high frequency signal. In various embodiments, the commands are modulated using amplitude modulation, frequency modulation, amplitude shift keying, frequency shift keying, or any other appropriate modulation scheme. In 906, the modulated commands are coupled into the high voltage power lines in the tether, and the process ends. In some embodiments, commands are coupled into the high voltage power lines by a communications system (e.g., communications system 156 of FIG. 1C). In some embodiments, commands are coupled into the high voltage power lines using ethernet over power line techniques.

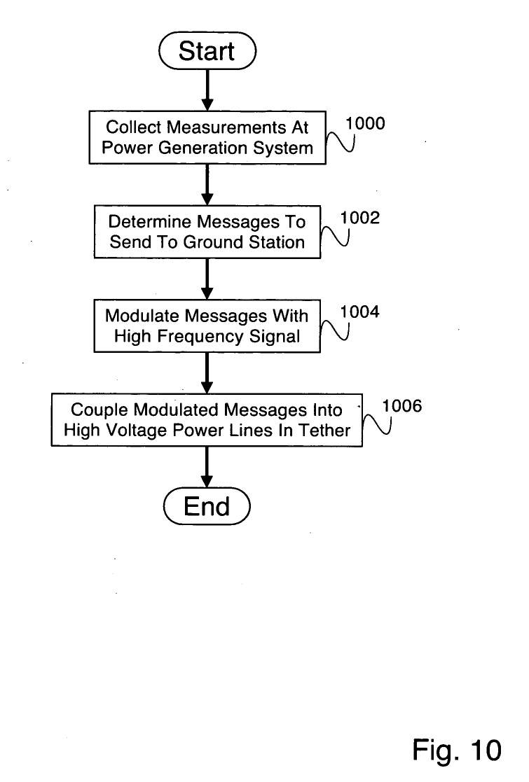

FIG. 10 is a flow diagram illustrating an embodiment of a process for communicating information from a tethered system for power generation with a ground station. In some embodiments, the tethered system for power generation is the tethered system for power generation of FIG. 1A. In some embodiments, the ground station is ground station 150 of FIG. 1C. In the example shown, in 1000 measurements are collected at the power generation system. In various embodiments, measurements are collected of temperature, wind speed, wind direction, flight speed, flight direction, propeller speed, tether (e.g., tether 152 of FIG. 1A) angle, tether tension, power generation level, or any other appropriate quantity. In 1002, messages are determined to send to the ground station. In some embodiments, the messages are determined from the measurements collected. In various embodiments, messages comprise status messages, measurement messages, information request messages, or any other appropriate messages. In 1004 the messages are modulated with a high frequency signal. In various embodiments, the messages are modulated using amplitude modulation, frequency modulation, amplitude shift keying, frequency shift keying, or any other appropriate modulation scheme. In 1006, the modulated messages are coupled into the high voltage power lines in the tether, and the process ends. In some embodiments, messages are received by a communications system (e.g., communications system 156 of FIG. 1C). In some embodiments, messages are coupled into the high voltage power lines using ethernet over power line techniques.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for power generation, comprising:
a wing for generating lift;
a turbine coupled to the wing, wherein the turbine is used for generating power from rotation of a propeller or for generating thrust using the propeller;
a tether, wherein one end of the tether is coupled to the wing; and
a tether tension sensor for determining a tension of the tether.

2. A system as in claim 1, further comprising a tether mount, wherein the tether mount includes the tether tension sensor.

3. A system as in claim 1, wherein the tether tension sensor comprises one or more of the following: an angle of attack sensor, a pitch rate sensor, an air speed sensor, or an orientation sensor.

4. A system as in claim 1, further comprising one or more of the following: a tether reinforcement structure or a wing bridling.

5. A system as in claim 1, further comprising a tether damage sensor.

6. A system as in claim 1, wherein the tether includes one or more accelerometers.

7. A system as in claim 1, further comprising an automatic control system for controlling position of the wing.

8. A system as in claim 7, wherein the position of the wing is estimated using one or more of the following: the line angle sensor, a light sensor, a LIDAR, a visible light sensor, a radio wave interferometric sensor, a RADAR, an ultrasonic sensor, a sonar mapper, or a microwave sensor.

9. A system as in claim 1, further comprising an inertial measurement unit for sensing a acceleration or rotation of the wing.

10. A system as in claim 1, further comprising a pitot tube for measuring air speed.

11. A system as in claim 1, wherein the wing comprises one or more flaps for controlling an orientation of the wing.

12. A system as in claim 1, wherein the wing comprises one or more lift generating surfaces.

13. A system as in claim 1, wherein the wing includes a wing flutter sensor.

14. A system as in claim 1, further comprising an ultrasonic range detector.

15. A system as in claim 1, further comprising a power distribution system for powering the aircraft systems from one or more of the following: power generated by the turbine or power supplied by a ground station.

16. A system as in claim 1, further comprising:
a processor configured to:
receive sensor measurements;
determine desired tether angles; and
send commands to actuators to achieve the desired tether angles.

17. A method for controlling a tethered system for power generation, comprising:
receiving sensor measurements;
determining a desired tether tension, wherein the desired tension is associated with a tether which has one end coupled to a wing, and wherein the wing is coupled to a turbine that is used for generating power from rotation of a propeller or for generating thrust using the propeller; and
sending a command to one or more actuators to achieve the desired tether tension.

18. A system for controlling a tethered system for power generation, comprising:
a wing for generating lift;
a turbine coupled to the wing, wherein the turbine is used for generating power from rotation of a propeller or for generating thrust using the propeller;
a tether, wherein one end of the tether is coupled to the wing; and
a wing orientation sensor, wherein the wing orientation sensor senses an orientation of the wing.

19. A system as in claim 18, further comprising:
a processor configured to:
receive sensor measurements;
determine desired wing orientation; and
send commands to actuators to achieve the desired wing orientation.

20. A method for controlling a tethered system for power generation, comprising:
receiving sensor measurements;
determining a desired wing orientation, wherein the desired wing orientation is associated with a wing which has one end coupled to a tether, and wherein the wing is coupled to a turbine that is used for generating power from rotation of a propeller or for generating thrust using the propeller; and
sending a command to one or more actuators to achieve the desired wing orientation.
